(19) United States
(12) Patent Application Publication
(10) Pub. No.: US 2007/0227013 A1
(43) Pub. Date: Oct. 4, 2007

(54) CONVERTIBLE PEELER

(75) Inventor: Sascha Kaposi, Tacoma, WA (US)

Correspondence Address: BLACK LOWE & GRAHAM, PLLC, 701 FIFTH AVENUE, SUITE 4800, SEATTLE, WA, 98104, US

(73) Assignee: Progressive International Corporation, Kent, WA (US)

(21) Appl. No.: 11/694,542

(22) Filed: Mar. 30, 2007

Related U.S. Application Data
(60) Provisional application No. 60/787,628, filed on Mar. 30, 2006.

(51) Int. Cl. A01D 1/00

(52) U.S. Cl. 30/279.6; 30/122

(57) ABSTRACT

A convertible peeler includes a cutting blade that is adjustable in more than one orientation. In a first orientation, the peeler can be used as a “Y-Peeler” so that the blade is generally orthogonal to the handle. In a second orientation, the peeler can be used as an in-line peeler so that the blade is generally parallel with the handle. In its preferred form, the blade can also be secured to a plurality of positions at a range of angles between parallel and orthogonal. In some examples of the invention, the blade can be adjustably secured to the handle by rotating a threaded fastener secured to the handle. Rotating the fastener in an opposite direction tightens the blade to hold it in the desired location.

### PRIORITY CLAIM

This application claims the benefit of U.S. Provisional Application Ser. No. 60/787,628, filed Mar. 30, 2006, which is hereby incorporated by reference.

### BACKGROUND OF THE INVENTION

Peelers for fruits, vegetables, and other foods are useful and well known. There are two primary types of peelers on the market, including a first type that includes a peeling blade that is generally in-line with and parallel to the peeler handle, and a second type that includes a peeler blade generally perpendicular to the handle. Each type is useful for particular peeling tasks, and neither is a perfect substitute for the other.

More recently, some have produced a hybrid peeler in which the peeler blade can be adjusted so that it is either a straight peeler or a perpendicular (or “Y”) peeler. The convertible peelers on the market, however, have shortcomings in the mechanisms that enable them to be converted from one version to the other. There is a need for an improved peeler that allows the blade to be quickly and securely adjusted between Y and straight versions.

### BRIEF DESCRIPTION OF THE DRAWINGS

Preferred and alternative embodiments of the present invention are described in detail below with reference to the following drawings.

FIG. 1 is a perspective view of a convertible peeler shown in a Y-peeler orientation;

FIG. 2 is a front view of a peeler shown in a Y-peeler orientation;

FIG. 3 is a side view of a peeler shown in a Y-peeler orientation;

FIG. 4 is a cross-sectional view of the peeler shown in a Y-peeler orientation, taken along the line A-A in FIG. 3;

FIG. 5 is a perspective view of a peeler shown in an in-line orientation;

FIG. 6 is a front view of a peeler shown in an in-line orientation;

FIG. 7 is a partial exploded view of a preferred convertible peeler; and

FIG. 8 is a perspective view of an upper portion of a handle of the preferred peeler.

### SUMMARY OF THE INVENTION

A preferred convertible peeler includes a cutting blade that is adjustable in more than one orientation. In a first orientation, the peeler can be used as a “Y-Peeler” so that the blade is generally orthogonal to the handle. In a second orientation, the peeler can be used as an in-line peeler so that the blade is generally parallel with the handle. In its preferred form, the blade can also be secured to a plurality of positions at a range of angles between parallel and orthogonal.

In accordance with a preferred example of the invention, the blade can be adjustably secured to the handle by rotating a threaded fastener secured to the handle. Rotating the fastener in an opposite direction tightens the blade to hold it in the desired location.

### DETAILED DESCRIPTION OF THE PREFERRED EMBODIMENT

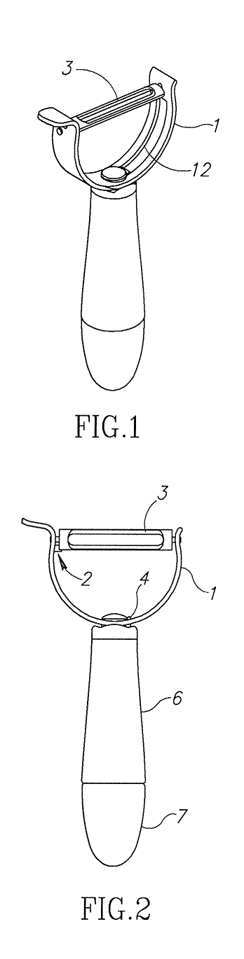

FIG. 1 shows a perspective view of a preferred convertible peeler. The same peeler is shown in FIGS. 2-8, but those views illustrate the peeler from different perspectives or orientations.

In the example shown, the preferred peeler includes a blade frame 1 that is formed from stainless steel. The frame may also be made from other metals, plastic, ceramic, or other materials that can provide the desired strength and rigidity to hold the blade. The blade frame is generally C-shaped, being configured to hold a peeler blade within the open side of the C. The curved C-shape facilitates an easy reconfiguration from Y-peeler to inline-peeler, as will be discussed further below. In alternate forms of the invention, however, the C-shape can take other shapes, including rectangular. The depth of the C may also vary, but is preferably sufficiently deep to enable peeled shavings to readily pass and to facilitate easy cleaning of the blade.

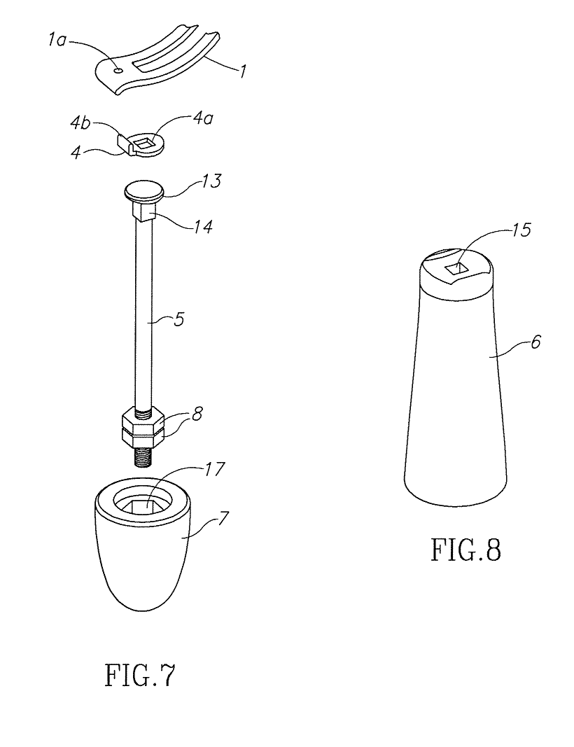

At each end of the blade frame 1, the blade frame includes a bore (e.g., 1a in FIG. 7) located to receive opposite ends of a peeler blade 3. The opposite ends of the peeler blade 3 each include a stem 3a, 3b (see FIG. 4) that is received within the bores of the blade frame 1 such that the blade is pivotably held within the blade frame.

The blade frame further includes a channel 12 extending substantially from one end of the frame (just adjacent one of the two bores) to a point approximately in the center of the C-shape of the blade frame 1. Thus, the channel forms an arc that defines an angle of approximately 90 degrees. A channel of such a length allows the blade frame to be rotated fully 90 degrees, thereby converting from in-line to Y positions. The channel may alternatively extend a shorter distance or a longer distance to allow a shorter or greater path of travel, including a channel that allows the peeler blade to be rotated 180 degrees.

The peeler blade comprises an elongated blade having a longitudinal center slot sharpened around the perimeter of the slot. The blade may be formed from stainless steel, plastic, ceramic, or other materials. The opposing longitudinal sides are preferably curved upward to provide a smooth surface to guide the vegetable or other object into the blade.

At the top of the blade frame another bore is configured to receive a first blade stop 2. The first blade stop is configured as a peg that is friction fit within the bore in a location that can engage one side of the peeler blade, as discussed below. A second blade stop 4 is secured to the handle adjacent the bottom of the blade frame to limit the pivotal movement of the blade, as discussed further below.

In one preferred example of the invention, the handle of the peeler is formed in several pieces, including a threaded pin 5 at the center. The threaded pin includes a shoulder or head 13 adjacent a shaft, with the shaft including a squared upper portion 14 that mates with a squared opening 4a within the second blade stop. The mating of the squared upper portion of the pin and that of the blade stop prevents rotation of the blade stop while it is retained within the shaft.

The pin 5 extends through the second blade stop, then through the channel in the blade frame in order to sandwich the second blade stop between the pin head and blade frame. The channel within the blade frame is sized and configured so that it snugly receives the squared upper portion of the pin while allowing sliding travel of the pin within the channel. Likewise, the size of the squared upper portion is sized to prevent rotational movement of the pin within the channel.

The pin then extends through an upper main handle core 6, which includes an internal bore sized to receive the pin, including an upper rectangular bore 15 that snugly receives a portion of the squared upper portion of the pin. The end of the pin opposite the head is threaded over a portion of its length in order to receive one or more nuts. One example of the invention includes two nuts 8 secured to the tail of the pin. The nuts engage a flat surface 16 of the upper main handle core in order to firmly secure the pin, frame, second blade stop, and upper handle core together.

A lower main handle core 7 serves as an adjustable twist knob and includes a hexagonal central bore 17 to receive the one or more nuts attached to the threaded end of the pin. The lower main handle core is friction fit or over-molded onto the nuts to securely hold it in place. The upper main handle core includes a peripheral shoulder that mates with a corresponding peripheral flange on the lower main handle core to allow for a sliding rotational relationship between the two sections. Thus, the lower main handle core is snap-fit onto the upper main handle core, with the tolerances such that the two handle core sections are held against one another while allowing them to be rotated with respect to one another.

The upper and lower inner handle cores optionally include an over-molded upper handle cover and lower handle cover. The handle covers are formed from santoprene, silicone, or other non-slip materials to provide a firm handle grip. In alternate examples of the invention, the handle may be formed from other materials, all in one piece, or without an external over-molded cover.

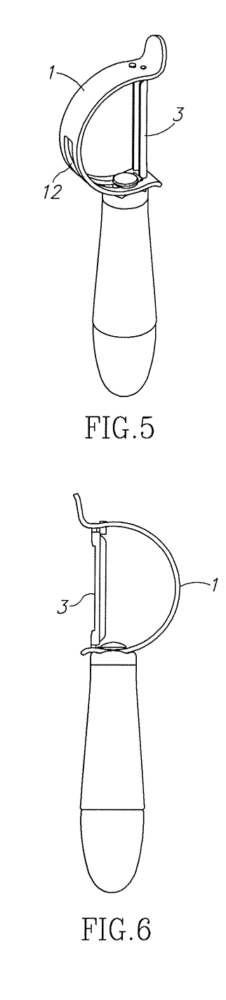

When fully constructed, a lip 4b formed on the second blade stop is configured to engage an inner concave surface of the peeler blade when the blade is configured in the in-line position (see FIG. 5). The lip is loosely received within the concave side of the peeler blade to allow some rotational movement of the blade while preventing excess blade rotation. Consequently, the blade 3 is allowed to pivot slightly in order to follow the contours of the item being peeled, but the degree of pivotal movement is restricted such that the blade always remains in contact with the surface of the item being peeled.

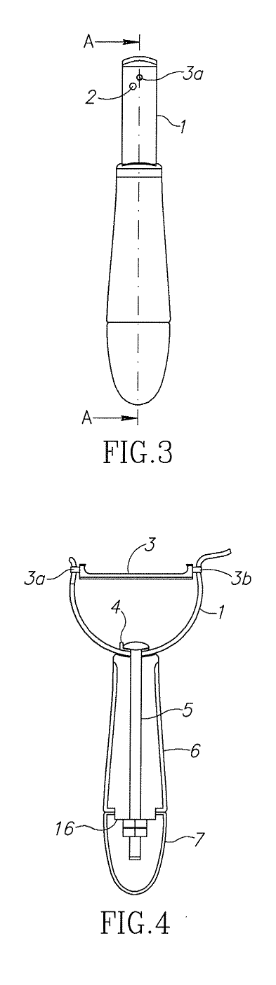

The second blade stop only engages the peeler blade 3 when the peeler is oriented in an in-line position as illustrated in FIG. 5. In the Y-peeler orientation of FIG. 1, the second blade stop is too far separated from the blade to affect its rotational movement. In the Y-peeler orientation, the first blade stop performs this function. Thus, the first blade stop 2 extends from the blade frame 1 inward that is, toward the center of the “C”) a sufficient distance such that it will engage a surface of the blade 3, thereby limiting its rotational movement. As best seen in FIG. 3, the first blade stop 2 is preferably positioned so that it does not lie in a plane dividing the peeler axially (as defined by line A-A in FIG. 3, with the plane extending orthogonally from the page), while the pivot stem 31 lines on the plane. As seen in FIG. 2, the first blade stop engages a surface of the peeler blade to limit rotational movement of the blade when oriented in the Y-peeler setting. In its preferred form, the first blade stop is frictionally secured within a bore within the blade frame 1 such that it can be moved axially inward (toward the blade 3) or outward (away from the blade 3). When moved outward, it does not engage the blade and thereby does not act as a stop, thereby allowing the blade to freely pivot or rotate.

The blade frame is held firmly in place by the nuts 8 as described above. In the preferred form of the invention, the nuts 8 are permanently molded into the lower handle core 7. Thus, when the blade frame is positioned in any desired setting, it is secured in place by tightening the nuts against a face or shoulder 16 of the lower handle core 6, thereby tightly sandwiching the blade frame 1 between the pin head 13 and the top surface of the handle core. The nuts are tightened or loosened by rotating the lower handle core 7 in the appropriate direction. Once loosened, the pin 5 may travel freely within the frame channel 12 so that the frame can be positioned as desired in an in-line, Y-peeler, or other location. The core (or twist-knob) is then tightened to secure the frame in place so that the used as desired.

While the preferred embodiment of the invention has been illustrated and noted above, many changes can be made without departing from the spirit and invention.

I claim:

1. A peeler, comprising:
a blade frame having a first end, a second end, and a central portion between the first end and the second end, the blade frame having a channel extending from a point adjacent the first end toward the central portion;
a peeler blade having a first end and a second end, the first end of the blade being pivotally secured to the first end of the blade frame and the second end of the blade being pivotally secured to the second end of the blade frame; and
a handle having an upper portion and a lower portion, the upper portion slideably secured to the channel of the blade frame, the lower portion of the handle being operably attached to the upper portion of the handle to releasably secure the upper portion of the handle to the blade frame in a desired position.

2. The peeler of claim 1, further comprising a pin having a first end and a second end, the first end having a head, and wherein the upper portion of the handle further comprises a central bore, the pin extending through the channel and the upper portion of the handle to retain the blade frame between the head and an upper surface of the handle.

3. The peeler of claim 2, wherein the pin further comprises an upper section adjacent the head of the pin, the upper section being substantially flat on opposing sides and engaging opposing surfaces of the channel of the blade frame to prevent rotational movement of the pin.

4. The peeler of claim 2, wherein the second end of the pin comprises external threads.

5. The peeler of claim 4, further comprising a nut threadably engaged with the external threads of the pin, the nut being received within a cavity formed in the lower portion of the handle, the cavity being configured to engage the nut for rotation substantially in unison with the nut.

6. The peeler of claim 5, wherein the cavity is hexagonal in shape and the lower portion of the handle is over-molded onto the nut.

7. The peeler of claim 5, wherein the lower portion of the handle is snap-fit onto the upper portion of the handle, and further wherein rotational movement of the lower portion of the handle with respect to the upper portion of the handle in a first direction urges the head of the pin toward the upper portion of the handle to more securely hold the blade frame in position.

8. The peeler of claim 1, wherein the blade frame forms a C shape.

9. The peeler of claim 8, wherein the channel forms an arc of approximately ninety degrees.

10. The peeler of claim 1, further comprising a first blade stop attached to the first end of the blade frame, the first blade stop being configured engage a surface of the blade to inhibit rotational movement of the blade.

11. The peeler of claim 10, further comprising a second blade stop secured to the handle, the second blade stop being configured engage a surface of the blade to inhibit rotational movement of the blade when the upper portion of the handle is secured to the blade frame such that the blade is substantially parallel with the handle.

12. The peeler of claim 10, wherein the first blade stop comprises a peg slideably received within the blade frame to occupy at least a first position for engaging a surface of the blade to inhibit rotational movement of the blade and a second position that does not inhibit rotational movement of the blade.

13. A peeler, comprising:
a blade frame having a first end, a second end, and a central portion between the first end and the second end, the blade frame having a channel extending from a point adjacent the first end toward the central portion;
a peeler blade having a first end and a second end, the first end of the blade being pivotally secured to the first end of the blade frame and the second end of the blade being pivotally secured to the second end of the blade frame; and
a handle having an first portion and a second portion, the first portion slideably secured to the channel of the blade frame, the second portion of the handle being operably attached to the first portion of the handle to releasably secure the first portion of the handle to the blade frame in a desired position.

14. The peeler of claim 13, further comprising a pin having a first end and a second end, the first end having a shoulder for engaging the blade frame, and wherein the first portion of the handle further comprises a central bore, the pin extending through the channel and into the first portion of the handle to retain the blade frame between the shoulder and an upper surface of the first portion of the handle.

15. The peeler of claim 14, wherein the second end of the pin further comprises external threads, the second portion of the handle having an internally threaded bore that engages the external threads of the pin.

16. The peeler of claim 15, wherein the internally threaded bore comprises a nut received within a cavity formed in the second portion of the handle, the cavity being configured to engage the nut for rotation substantially in unison with the nut.
